(19) United States
(12) Patent Application Publication
(10) Pub. No.: US 2015/0043421 A1
(43) Pub. Date: Feb. 12, 2015

(54) WIRELESS RELAY APPARATUS, COMMUNICATION SYSTEM, AND COMMUNICATION METHOD

(71) Applicant: FUJITSU LIMITED, Kawasaki-shi (JP)

(72) Inventor: TAKAO SHIMIZU, Meguro (JP)

(21) Appl. No.: 14/329,538

(22) Filed: Jul. 11, 2014

(30) Foreign Application Priority Data
Aug. 8, 2013 (JP) 2013-165243

(51) Int. Cl. H04B 7/155; H04W 84/12

(52) U.S. Cl. CPC H04B 7/15521; H04W 84/12
USPC 370/315

(57) ABSTRACT

There is provided a wireless relay apparatus that is communicably connected to a wireless terminal through a wireless LAN each other and is communicably connected to an information processing apparatus through a WAN. The wireless relay apparatus includes a wireless communication unit configured to receive a frame containing data specifying a predetermined first protocol in a higher layer payload type field in a layer 2 header from the wireless terminal and a processor configured to execute a process that causes the wireless relay apparatus to perform establishing a TCP (Transmission Control Protocol) connection to and from the information processing apparatus when the wireless communication unit receives the frame containing the data specifying the predetermined first protocol in the higher layer payload type field in the layer 2 header, wherein the wireless communication unit transfers data received from the information processing apparatus to the wireless terminal.

### CROSS-REFERENCE TO RELATED APPLICATION

This application is based upon and claims the benefit of priority of the prior Japanese Patent Application No. 2013-165243, filed on Aug. 8, 2013, the entire contents of which are incorporated herein by reference.

### FIELD

The embodiments discussed herein are related to a wireless relay apparatus, a communication system, and a communication method.

### BACKGROUND

A TCP (Transmission Control Protocol) establishes a connection between a transmitting side and a receiving side and makes a confirmation for each data transmission, thereby achieving data communication with high reliability. The TCP is used for many Internet accesses such as Web accesses. In the TCP, many control messages are transmitted and received between the transmitting side and the receiving side to ensure the reliability. The TCP uses two channels, one for upstream and one for downstream, for net communication, and uses a total of eight upstream and downstream channels to exchange control messages for net communication.

### DOCUMENTS OF PRIOR ARTS

### Patent Document

[Patent document 1] Japanese Laid-Open Patent Publication No. 2000-253150

[Patent document 2] Japanese Laid-Open Patent Publication No. 09-321821

[Patent document 3] Japanese Laid-Open Patent Publication No. 2006-323455

### SUMMARY

An embodiment provides a wireless relay apparatus that is communicably connected to a wireless terminal through a wireless LAN (Local Area Network) each other and is communicably connected to an information processing apparatus through a WAN (Wide Area Network), the wireless relay apparatus including:

a wireless communication unit configured to receive a frame containing data specifying a predetermined first protocol in a higher layer payload type field in a layer 2 header from the wireless terminal; and

a processor configured to execute a process that causes the wireless relay apparatus to

perform establishing a TCP (Transmission Control Protocol) connection to and from the information processing apparatus when the wireless communication unit receives the frame containing the data specifying the predetermined first protocol in the higher layer payload type field in the layer 2 header, wherein

the wireless communication unit transfers data received from the information processing apparatus to the wireless terminal.

The object and advantages of the invention will be realized and attained by means of the elements and combinations particularly pointed out in the claims. It is to be understood that both the foregoing general description and the following detailed description are exemplary and explanatory and are not restrictive of the invention.

### BRIEF DESCRIPTION OF DRAWINGS

FIG. 1 illustrates an example of a configuration of a system of an embodiment;

FIG. 2 illustrates an example of a configuration of an access point;

FIG. 3 illustrates an example of a configuration of a wireless terminal;

FIG. 4 illustrates an example (1/2) of an operation sequence of the embodiment;

FIG. 5 illustrates an example (2/2) of the operation sequence of the embodiment;

FIG. 6 illustrates an example of information contained in notification information;

FIG. 7 illustrates an example of a frame of a packet transmitted from the wireless terminal to the access point for TCP proxy delegation;

FIG. 8 illustrates an example (1/3) of an operation sequence for a first modification;

FIG. 9 illustrates an example (2/3) of the operation sequence for the first modification;

FIG. 10 illustrates an example (3/3) of the operation sequence for the first modification;

FIG. 11 illustrates an example of an operation sequence for a second modification;

FIG. 12 illustrates an example (1/3) of an operation sequence of a communication method between the wireless terminal and the access point;

FIG. 13 illustrates an example (2/3) of the operation sequence of the communication method between the wireless terminal and the access point;

FIG. 14 illustrates an example (3/3) of the operation sequence of the communication method between the wireless terminal and the access point;

FIG. 15 illustrates an example of a schedule table of priority data; and

FIG. 16 illustrates an example of a schedule table of best effort data.

### DESCRIPTION OF EMBODIMENTS

The TCP may be used to access a server from a wireless terminal through a wireless LAN (Local Area Network) for wireless communication between an AP (access point) and the wireless terminal and a WAN (Wide Area Network) connecting between the AP and the server. In this case, retransmission may occur due to noise or the like in the wireless LAN (Wi-Fi: Wireless Fidelity) segment. An increase in retransmission increases the processing load in the wireless terminal, the AP, and the server.

Hereinafter, an embodiment will be described with reference to drawings. The configuration of the embodiment is an exemplification, and the disclosed configuration is not limited to the specific structure of the disclosed embodiment. When the disclosed configuration is implemented, a specific configuration in accordance with the embodiment may be employed as appropriate.

### First Embodiment

Hereinafter, an embodiment will be described with reference to drawings. The configuration of the embodiment is an exemplification and is not limited to the configuration of the disclosed embodiment. The present embodiment is assumed to be applied to an access point and a wireless terminal having a wireless LAN function, but the communication method of the present embodiment is not limited to be applied to the wireless LAN.

### Configuration Example

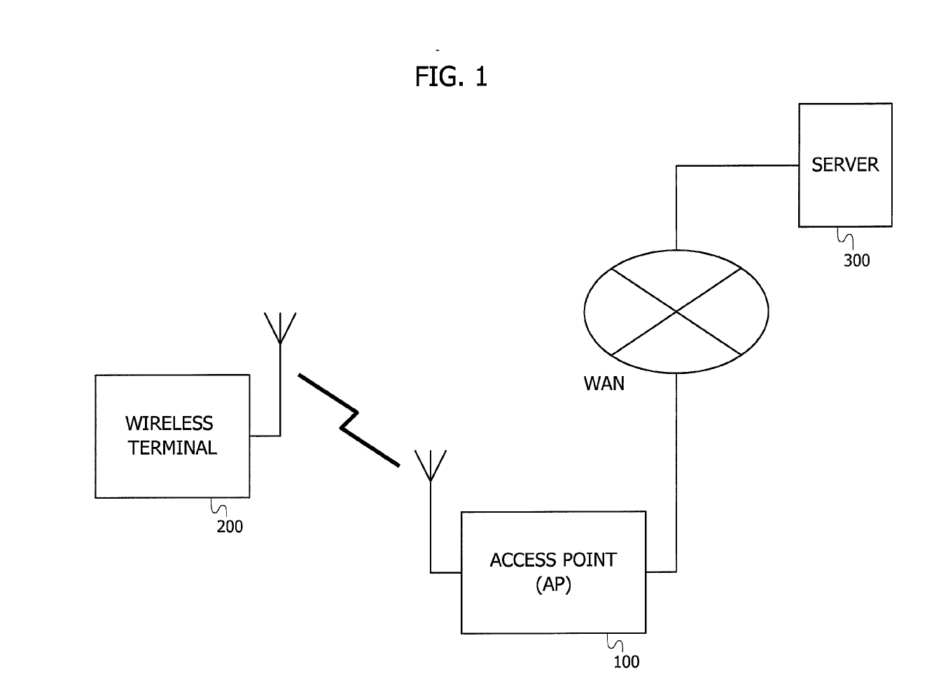

FIG. 1 illustrates an example of a configuration of a system of the present embodiment. The system of the present embodiment includes an access point (AP) 100, a wireless terminal 200, and a server 300. The access point 100 is wirelessly connected to the wireless terminal 200. In the system of the present embodiment, the number of wireless terminals is not limited to one, but two or more terminals may be used. The access point 100 is connected to a higher level network (WAN: Wide Area Network). The higher level network is connected to the server 300. In the system of the present embodiment, the number of servers is not limited to one, but two or more servers may be used.

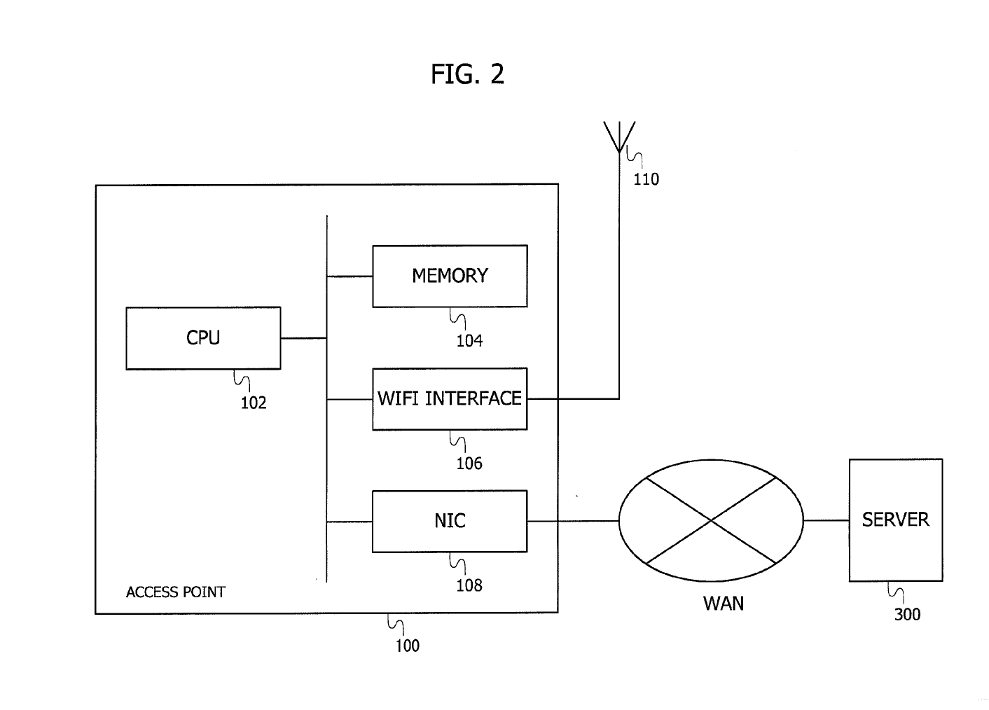

FIG. 2 illustrates an example of a configuration of the access point. The access point 100 includes a CPU 102, a memory 104, a Wi-Fi interface 106, a NIC (Network Interface Card) 108, and an antenna 110. The access point 100 is an example of a wireless relay apparatus.

The CPU 102 performs control and a predetermined arithmetic operation of the access point 100. The CPU 102 processes data transmitted and received to and from other communication apparatuses. The CPU 102 is an example of a control unit.

The memory 104 stores programs to be executed by the CPU 102, data to be used by the CPU 102, and the like. The memory 104 stores programs for achieving the TCP proxy function and the like.

The Wi-Fi interface 106 is an interface for wirelessly connecting the wireless terminal 200 and other wireless apparatuses. The Wi-Fi interface 106 is an example of a wireless communication unit.

The NIC (Network Interface Card) 108 is an interface for connecting the access point 100 to a higher level network. The access point 100 is connected to the server 300 and other higher level apparatuses through the NIC 108 and a network. The access point 100 transmits and receives data to and from the server 300 and other higher level apparatuses through the NIC 108. The NIC 108 is an example of a communication unit.

The antenna 110 receives wireless signals transmitted from the wireless terminal 200 and other wireless apparatuses. The antenna 110 also transmits wireless signals to the wireless terminal 200 and other wireless apparatuses. The access point 100 transmits and receives data and the like to and from the wireless terminal 200 through the Wi-Fi interface 106 and the antenna 110.

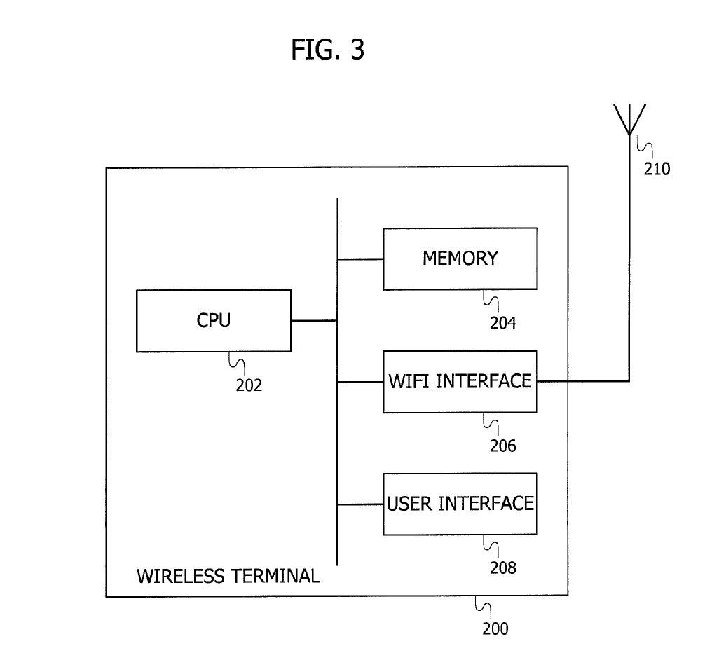

FIG. 3 illustrates an example of a configuration of the wireless terminal. The wireless terminal 200 includes a CPU 202, a memory 204, a Wi-Fi interface 206, and a user interface 208.

The CPU 202 performs control and a predetermined arithmetic operation of the wireless terminal 200. The CPU 202 processes data transmitted and received to and from other communication apparatuses. The CPU 202 is an example of a control unit.

The memory 204 stores programs to be executed by the CPU 202, data to be used by the CPU 202, and the like.

The Wi-Fi interface 206 is an interface for wirelessly connecting the access point 100 and other wireless apparatuses. The Wi-Fi interface 206 is an example of the wireless communication unit.

The user interface 208 is an interface for exchanging information to and from a user of the wireless terminal 200. The user interface 208 includes an input device and an output device.

The antenna 210 receives wireless signals transmitted from the access point 100 and other wireless apparatuses. The antenna 210 also transmits wireless signals to the access point 100 and other wireless apparatuses. The wireless terminal 200 transmits and receives data and the like to and from the access point 100 through the Wi-Fi interface 206 and the antenna 210.

The server 300 has includes as an HTTP (Hyper Text Transfer Protocol) server. The server 300 may include as an SSL (Secure Socket Layer) server and a SIP (Session Initiation Protocol) server. A server includes the HTTP server, the SSL server, and the SIP server may be provided as a separate server. The server 300 is connected to a network and can be communicated to the access point 100 through the network.

The access point 100, the wireless terminal 200, and the server 300 can be implemented using a general-purpose computer such as a personal computer (PC) or a dedicated computer such as a server machine. The wireless terminal 200 can also be implemented using a dedicated or general-purpose computer such as a smartphone, a mobile phone, and a car navigation device, or an electronic apparatus including a computer.

The computer, namely, an information processing apparatus includes a processor, a main memory, a secondary storage, and an interface device to and from a peripheral device such as a communication interface device. The main memory and the secondary storage device are a computer-readable recording medium.

The processor loads a program stored in a recording medium to a work area of the main memory and executes the program; and the execution of the program controls the peripheral device, whereby the computer can achieve the processing that meet the intended purpose.

Examples of the processor include a CPU (Central Processing Unit) and a DSP (Digital Signal Processor). Examples of the main memory include a RAM (Random Access Memory) and a ROM (Read Only Memory).

The Examples of the secondary storage include an EPROM (Erasable Programmable ROM) and a hard disk drive (HDD). The secondary storage can also include a removable medium, namely, a portable recording medium. Examples of the removable medium include a USB (Universal Serial Bus) memory, and a disc recording medium such as a CD (Compact Disc) and a DVD (Digital Versatile Disc).

Examples of the communication interface device include a LAN (Local Area Network) interface board and a wireless communication circuit for wireless communication.

The peripheral device includes not only the aforementioned secondary storage and communication interface device, but also an input device such as a keyboard and a pointing device, and an output device such as a display device and a printer. The input device can also include a device for inputting videos and images such as a camera, and a device for inputting voice such as a microphone. The output device can also include a device for outputting voice such as a speaker. The peripheral device may be included in the computer. In other words, the peripheral device may be part of the computer configuration.

The processor loads the program stored in the secondary storage into the main memory and executes the program, whereby the computer used as the access point 100 achieves the processing such as data exchange and schedule table generation. Meanwhile, the memory 104 is provided in a storage area of the main memory or the secondary storage.

The processor loads the program stored in the secondary storage into the main memory and executes the program, whereby the computer used as the wireless terminal 200 achieves the processing such as data exchange and phone calling. Meanwhile, the memory 204 is provided in a storage area of the main memory or the secondary storage.

The processor loads the program stored in the secondary storage into the main memory and executes the program, whereby the computer used as the server 300 achieves data exchange, and implements the Web server, the SSL server, the SIP server, and the like.

Each unit of the access point 100, the wireless terminal 200, and the server 300 can be implemented as a hardware component, a software component, or a combination thereof.

The hardware component is a hardware circuit, and examples thereof include a combination of an FPGA (Field Programmable Gate Array), an application specific integrated circuit (ASIC), a gate array, and a logic gate, and an analog circuit.

The software component is a part of implementing a predetermined process as software. The software component is not a concept of limiting the software implementation language, the development environment, or the like.

The series of processes can be executed by hardware or can also be executed by software.

The program coding steps include a process to be performed chronologically in the coded sequence as well as a process not to be performed chronologically but to be performed parallel or individually.

The information processing apparatus stores an operating system, various programs, various tables, and the like in the main memory and the secondary storage. The operating system is software for performing mediation between software and hardware, memory space management, file management, process management, task management, and other managements. The operating system includes a communication interface. The communication interface is a program for exchanging data to and from other external devices and the like connected through the communication unit.

### Operation Example

Here, an operation example will be described assuming that the wireless terminal 200 delegates the communication to the access point 100 for TCP communication to and from the server 300.

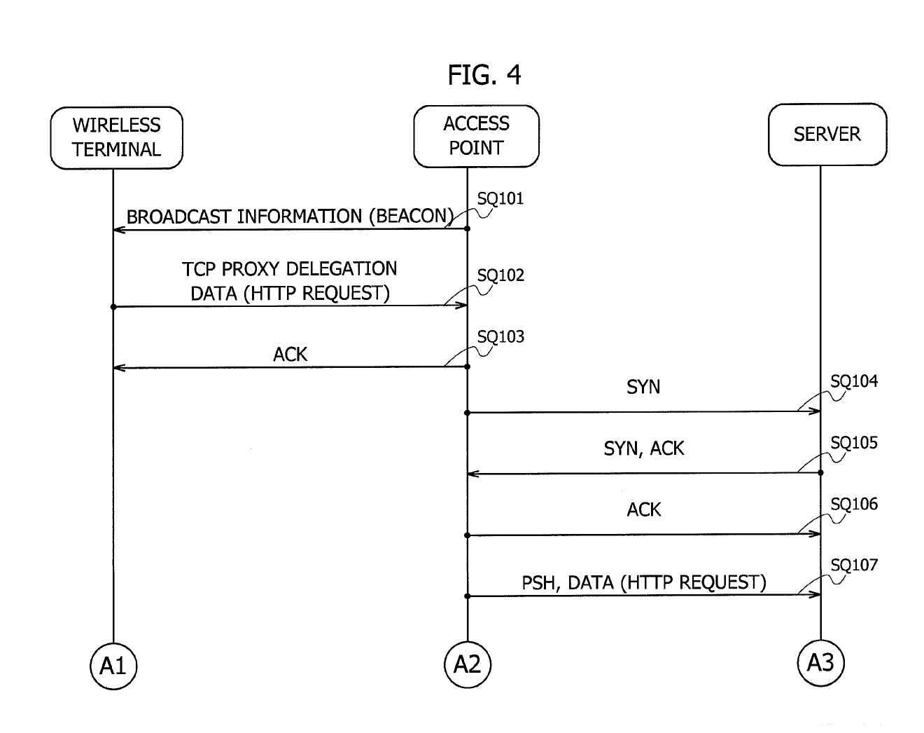

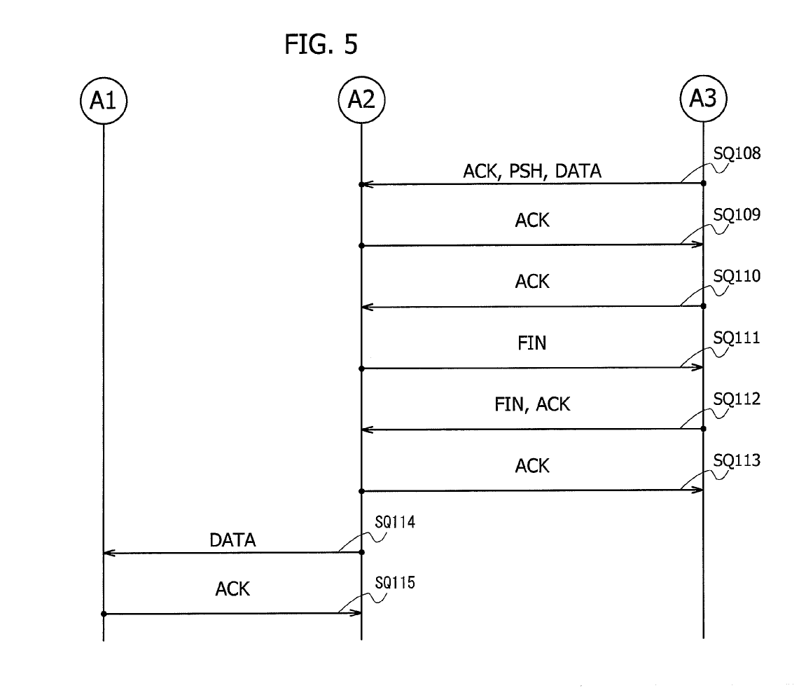

FIGS. 4 and 5 illustrate examples of an operation sequence of the present embodiment. The operation sequences in FIGS. 4 and 5 are examples of the operation sequences of the access point 100, the wireless terminal 200, and the server 300. “A1”, “A2”, and “A3” in FIG. 4 are connected to “A1”, “A2”, and “A3” in FIG. 5 respectively.

The access point 100 transmits notification information toward wireless terminals present around the access point 100 every predetermined time (SQ101).

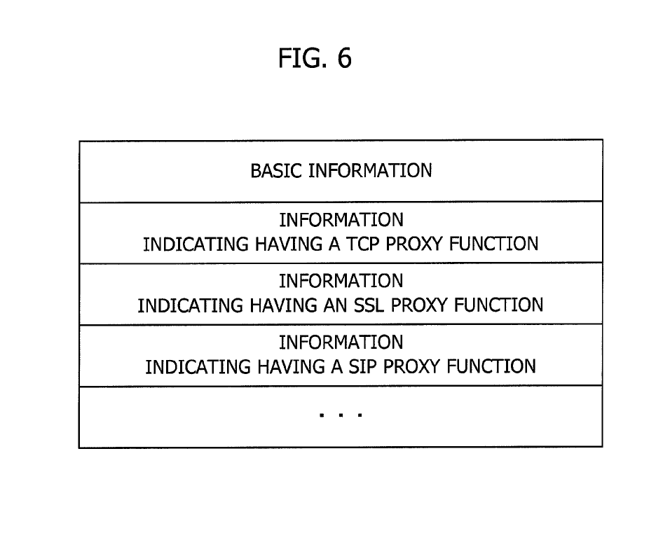

FIG. 6 illustrates an example of information contained in the notification information. In the example of FIG. 6, the notification information includes basic information, information indicating having a TCP proxy function, information indicating having an SSL proxy function, information indicating having a SIP proxy function, and the like. The information indicating having a proxy function such as the TCP proxy function may be respectively represented by presence or absence of a predetermined flag. Alternatively, the information indicating having a proxy function such as the TCP proxy function may be represented, for example, by data specifying a predetermined protocol.

The examples of the basic information include information for identifying a network (for example, ESSID), information for identifying a protocol for use in communication (for example, protocol ID), and an encryption scheme.

The information indicating having the TCP proxy function is information indicating that the access point 100 has the TCP proxy function. The TCP proxy function is a function where the access point 100 on behalf of the wireless terminal 200 exchanges TCP control messages to and from the server 300. The TCP proxy function is a function that receives data other than the TCP control messages from the wireless terminal 200 and transmits the data to the server 300. The TCP proxy function is also a function that receives data other than the TCP control messages from the server 300 and transmits the data to the wireless terminal 200.

From the notification information, the wireless terminal 200 recognizes that the access point 100 has the TCP proxy function.

The wireless terminal 200 transmits a frame containing the information indicating the TCP proxy delegation and data addressed to the server (here assuming an HTTP request) to the access point 100 (SQ102). The access point 100 is an access point having the TCP proxy function. Here, the data addressed to the server is assumed to be an HTTP request, but may be data of other service or application. The wireless terminal 200 transmits the information indicating the TCP proxy delegation to the access point 100, whereby the wireless terminal 200 can delegate the exchange with the server 300 using the TCP to the access point 100. The HTTP request is generated, for example, when a user of the wireless terminal 200 operates a Web browser of the wireless terminal 200.

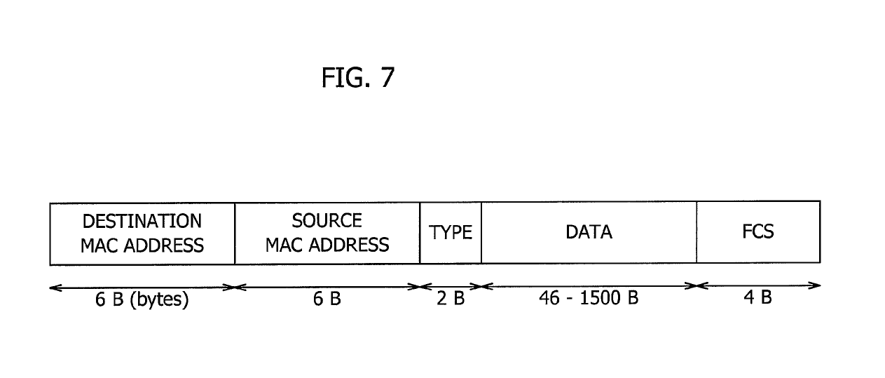

FIG. 7 illustrates an example of a frame of a packet transmitted from the wireless terminal to the access point for TCP proxy delegation. In the example of FIG. 7, the frame includes a destination MAC address, a source MAC address, a type, data, and an FCS. The destination MAC address, the source MAC address, and the type constitute an L2 (Layer 2) header. The data (payload data) is used by a higher layer (L3 (Layer 3) or higher).

The destination MAC address of the L2 header contains the MAC address of the access point 100 as the destination of the packet.

The source address of the L2 header contains the MAC address of the wireless terminal 200 as the source of the packet.

The type of the L2 header contains a type (kind) of data of the higher layer (L3 (Layer 3) or higher) contained in the data (payload data). Here, the type of the data contains predetermined information indicating the TCP proxy delegation to the access point 100. The type of the L2 header may contain information indicating proxy delegation of other functions. The type of the L2 header is an example of a higher layer payload type field. The information indicating the proxy delegation is represented, for example, by data specifying a predetermined protocol.

The data (payload data) contains data to be used by the higher layer (L3 or higher). Examples of the data include an HTTP request. The data may contain an IP header, a TCP header, and the like. The information contained in the data is the same as conventional.

The FCS (Frame Check Sequence) contains CRC (Cyclic Redundancy Check) information for detecting an error calculated from each field.

The frame of the packet transmitted from the wireless terminal to the access point for TCP proxy delegation is not limited to the example of FIG. 7, but a frame in another format containing predetermined information indicating the TCP proxy delegation to the access point 100 may be used.

The access point 100 receives the frame from the wireless terminal 200. In response to the received frame, the access point transmits a frame containing an acknowledgement response (ACK) to the wireless terminal 200 (SQ103).

The access point 100 acquires the type of the L2 header in the frame received from the wireless terminal 200. The access point 100 confirms that the type of the L2 header contains information indicating the TCP proxy delegation. The access point 100 also acquires the HTTP request from the data in the frame. The HTTP request is a request addressed to the server 300. The information indicating the TCP proxy delegation stored in the type of the L2 header is preset. The access point 100 receives the frame from the wireless terminal 200 and recognizes that the wireless terminal 200 requests the access point 100 to transmit the HTTP request to the server 300 using the TCP on behalf of the wireless terminal 200. The information indicating the TCP proxy delegation is represented, for example, as an RTCP/IP (Reduced Transmission Control Protocol/Internet Protocol).

The access point 100 transmits a frame containing a connection establishment request to the server 300 (SQ104). More specifically, the access point 100 sets a SYN (Synchronize) flag of control bits in the TCP header to ON and transmits the SYN flag to the server 300.

The server 300 transmits a frame containing a response to the connection establishment request to the access point 100 (SQ105). More specifically, the server 300 sets the SYN (Synchronize) flag of the control bits in the TCP header and an ACK (Acknowledgement) flag to ON and transmits the flags to the access point 100.

The access point 100 transmits a frame containing the acknowledgement response to the server 300 (SQ106). More specifically, the access point 100 sets the ACK flag of the control bits in the TCP header to ON and transmits the flag to the server 300.

This establishes a TCP connection between the access point 100 and the server 300.

The access point 100 transmits a frame containing data such as the HTTP request to the server 300 (SQ107). More specifically, the access point 100 sets a PSH (Push) flag of the control bits in the TCP header to ON and transmits the PSH flag together with data of the HTTP request and the like to the server 300. The data of the HTTP request and the like is the data transmitted from the wireless terminal 200.

The server 300 transmits a frame containing data (user data) to be transmitted to the access point 100 from the server 300 and the acknowledgement response to the access point 100 (SQ108). More specifically, the server 300 sets the ACK flag and the PSH flag of the control bits in the TCP header to ON and transmits the flags together with the data (user data) to be transmitted to the access point 100, to the access point 100. Examples of the data (user data) include a response (HTTP response) to the HTTP request.

When the data (user data) and the acknowledgement response are received, the access point 100 transmits a frame containing the acknowledgement response to the server 300 (SQ109). More specifically, the access point 100 sets the ACK flag of the control bits in the TCP header to ON and transmits the ACK flag to the server 300. The access point 100 stores the received data (user data) in the memory 104.

When the acknowledgement response is received, the server 300 transmits a frame containing the acknowledgement response to the access point 100 (SQ110). More specifically, the server 300 sets the ACK flag of the control bits in the TCP header to ON and transmits the flag to the access point 100.

The access point 100 transmits a frame containing a transmission completion notification to the server 300 (SQ111). More specifically, the access point 100 sets a FIN (Finish) flag of the control bits in the TCP header to ON and transmits the flag to the server 300 (SQ111). From this point forward, the access point 100 is prohibited from transmitting data to the server 300.

The server 300 transmits a frame containing a response to the transmission completion notification to the access point 100 (SQ112). More specifically, the server 300 sets the ACK flag and the FIN flag of the control bits in the TCP header to ON and transmits the flags to the access point 100.

The access point 100 transmits the acknowledgement response to the server 300 (SQ113). More specifically, the access point 100 sets the ACK flag of the control bits in the TCP header to ON and transmits the flag to the server 300.

This completes the TCP connection between the access point 100 and the server 300.

The access point 100 reads the data (user data) received from the server 300, from the memory 104, and transmits the data to the wireless terminal 200 (SQ114). For example, based on the received data, the wireless terminal 200 generates screen data to be displayed by a Web browser and displays the screen data on a screen of the wireless terminal 200.

When the data is received from the access point 100, the wireless terminal 200 transmits a frame containing the acknowledgement response to the access point 100 (SQ115).

Then, the wireless terminal 200 transmits the HTTP request to the server 300. The wireless terminal 200 also receives the HTTP response from the server 300. The wireless terminal 200 does not transmit or receive control data to and from the server 300. Thus, communication traffic is reduced between the wireless terminal 200 and the access point 100.

The access point 100 also performs TCP communication with the server 300. Thus, the reliability of TCP communication between the access point 100 and the server 300 is ensured.

When the TCP connection is established between the access point 100 and the server 300, the source address of the access point 100 may be the address of the access point 100 or the address of the wireless terminal 200. When the address of the wireless terminal 200 is used as the source address, the destination address of the control message from the server 300 is the address of the wireless terminal 200. At this time, the access point 100 does not transmit the control message to the wireless terminal 200, but processes the control message within the access point 100.

<First Modification>

Here, the description will focus on an operation example in which the wireless terminal 200 delegates the communication for SSL session establishment with the server 300 to the access point 100. Note that a description of points in common with the above described example will be omitted.

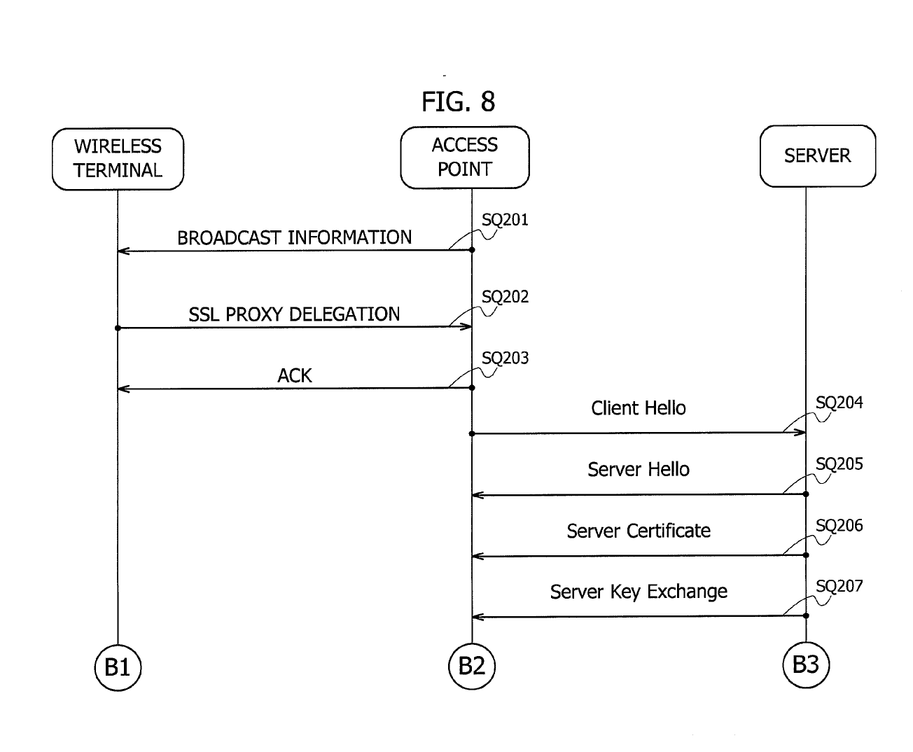

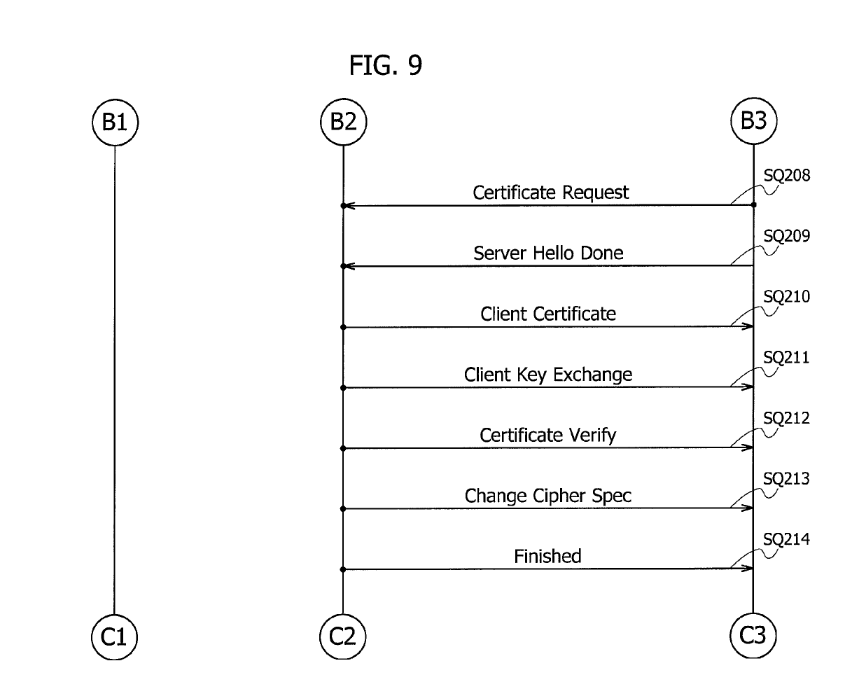

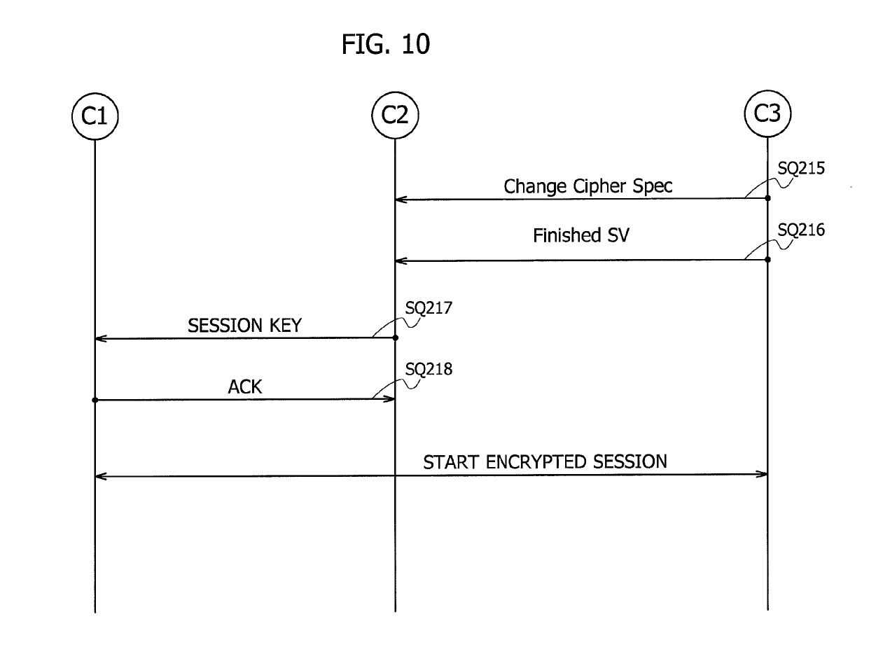

FIGS. 8, 9, and 10 each illustrate an example of an operation sequence for the present modification. Each of the operation sequence in FIGS. 8, 9, and 10 illustrates an example of the operation sequence of the access point 100, the wireless terminal 200, and the server 300. “B1”, “B2”, and “B3” in FIG. 8 are connected to “B1”, “B2”, and “B3” in FIG. 9 respectively. “C1”, “C2”, and “C3” in FIG. 9 are connected to “C1”, “C2”, and “C3” in FIG. 10 respectively.

The access point 100 transmits notification information toward a wireless terminal present around the access point 100 every predetermined time (SQ201). Here, the notification information includes information indicating that the access point 100 has an SSL proxy function.

From the notification information, the wireless terminal 200 recognizes that the access point 100 has the SSL proxy function.

The wireless terminal 200 transmits a frame containing the information indicating the SSL proxy delegation to the access point 100 (SQ202). The access point 100 is an access point having the SSL proxy function. The wireless terminal 200 transmits the information indicating the SSL proxy delegation to the access point 100, whereby the wireless terminal 200 can delegate the exchange for SSL session establishment with the server 300 to the access point 100.

The access point 100 receives the frame from the wireless terminal 200. In response to the received frame, the access point transmits an acknowledgement response (ACK) to the wireless terminal 200 (SQ203).

From the information indicating the SSL proxy delegation in the received frame, the access point 100 recognizes that the SSL proxy is delegated. The access point 100 transmits a frame containing a Client Hello to the server 300 (SQ204). The server 300 is a server requested by the wireless terminal 200 for SSL connection. The Client Hello is information transmitted when the wireless terminal 200 is to connect the server 300 for the first time. The Client Hello contains a list of an encryption algorithm and a compression algorithm to be used. When an existing session is resumed, a session ID is also transmitted. The list of the encryption algorithm and the compression algorithm to be used may be transmitted together with the information indicating the SSL proxy delegation to be transmitted from the wireless terminal 200 to the access point 100.

The server 300 transmits a frame containing an SV Hello (Server Hello) to the access point 100 (SQ205). The server 300 specifies which algorithm is used from the list of the encryption algorithm and the compression algorithm transmitted from the access point 100. When the session ID is also received, the server 300 resumes the existing session if the resumption of the existing session specified by the session ID is permitted. This determines the security processing method. Examples of the security processing method include the protocol version, the session ID, the encryption algorithm, the compression algorithm, and the like.

The server 300 transmits a frame containing a certificate of the server 300 itself (Server Certificate) to the access point 100 (SQ206). The data format of the server certificate is a format including the list of all the certificates up to the root certificate authority. If the server 300 does not have the certificate of the server 300 itself, or if the certificate of the server 300 itself does not contain a key exchangeable public key, the server 300 transmits a frame containing an SV key exchange (Server Key Exchange) to the access point 100 (SQ207). More specifically, the server 300 temporarily generates an RSA key, adds the server signature thereto, and transmits them to the access point 100. The server 300 transmits a frame containing a client certificate request (Certificate Request) to the access point 100 (SQ208). The client certificate request is a message to be transmitted when the server 300 requests the presentation of the certificate of the wireless terminal 200. The list of the certificate authority trusted by the server 300 is added to the message.

The server 300 transmits a frame containing an SV hello complete (Server Hello Done) to the access point 100 (SQ209). This completes hello message exchange.

When the client certificate request is received from the server 300, the access point 100 transmits a frame containing the client certificate (Client Certification) to the server 300 (SQ210). If the access point 100 does not have a certificate appropriate for the request from the server 300, the access point 100 returns a no_certificate alert. The data format of the client certificate is the same as that of the server certificate.

The access point 100 transmits a frame containing a client key exchange (Client Key Exchange) to the server 300 (SQ211). The client key exchange is information for generating a key for use in an encrypted communication. The access point 100 uses a negotiated encryption algorithm to generate pre-master secret data and encrypt the pre-master secret data, and then transmits the pre-master secret data to the server 300. The pre-master secret data is source data from which to generate a master secret for use in generating a session key for encryption.

When the access point 100 transmits the client certificate to the server 300, the access point 100 generates a signature and transmits the signature to the server 300 (SQ212). The access point 100 calculates a hash value from the data until now, and transmits the signature encrypted by the secret key on the side of the access point 100 to the server 300. The server 300 uses a client public key to decrypt the signature received from the access point 100, and compares the signature with the acquired hash value to verify the signature.

The access point 100 transmits a frame containing Change Cipher Spec to the server 300 (SQ213). The Change Cipher Spec is a message declaring that the communication is performed using the encryption algorithm determined with the server 300.

The access point 100 transmits a frame containing client side finish (Finished) to the server (SQ214). The client side finish is a message informing the server 300 that the exchange with the server 300 is normally terminated and data for session establishment is ready.

The server 300 transmits a frame containing Change Cipher Spec to the access point 100 (SQ215). The Change Cipher Spec is a message declaring that the communication is performed using the encryption algorithm determined with the access point 100.

The server 300 transmits a frame containing SV side finish (Finished) to the access point 100 (SQ216). The SV side finish is a message informing the access point 100 that the exchange with the access point 100 is normally terminated and data for session establishment is ready.

This completes the verification between the access point 100 and the server 300.

The access point 100 generates a session key from the pre-master secret data and transmits the pre-master secret data to the wireless terminal 200. The access point 100 also transmits information about the security processing method determined with the server 300 to the wireless terminal 200.

When the session key and the information about the security processing method are received, the wireless terminal 200 transmits the acknowledgement response (ACK) to the access point 100.

This starts the SSL session between the wireless terminal 200 and the server 300.

The wireless terminal 200 starts the encrypted communication with the server 300 based on the session key and the information about the security processing method received from the access point 100. For example, the wireless terminal 200 encrypts the HTTP request and transmits the encrypted HTTP request to the server 300 through the access point 100. Then, the server 300 encrypts the response to the HTTP request (HTTP response) and transmits the encrypted HTTP response to the wireless terminal 200 through the access point 100.

When the access point 100 receives a client certificate request from the server 300, the following three options can be considered.

(1) When the proxy is requested, the wireless terminal 200 passes the public certificate (client certificate) of the wireless terminal 200 to the access point 100. (2) The access point 100 suspends the SSL proxy by the access point 100, and establishes an SSL session between the wireless terminal 200 and the server 300. (3) The access point 100 uses the public certificate (client certificate) of the access point 100 to establish an SSL session with the server 300.

For example, at login authentication, the wireless terminal 200 can inform the access point 100 which option is selected. Alternatively, at SSL proxy delegation, the wireless terminal 200 may inform the access point 100 which option is selected.

When the information indicating the SSL proxy delegation is received from the wireless terminal 200, the access point 100 establishes the SSL session with the server 300. The access point 100 establishes the SSL session with the server 300 without exchanging with the wireless terminal 200. The wireless terminal 200 can use the SSL session established by the access point 100 to communicate with the server 300. The communication between the wireless terminal 200 and the access point 100 is not performed until the SSL session is established, which improves the communication efficiency in wireless bandwidth between the wireless terminal 200 and the access point 100.

The encrypted communication using the SSL is not performed between the wireless terminal 200 and the access point 100. However, an encrypted communication using a wireless LAN according to a normal method or the like is performed between the wireless terminal 200 and the access point 100, whereby communication security is ensured. Therefore, a communication with high security can be performed between the wireless terminal 200 and the server 300.

<Second Modification>

Here, the description will focus on an operation example in which the wireless terminal 200 delegates the communication for call initiation using the SIP with the server 300 to the access point 100. Note that a description of points in common with the above described examples will be omitted.

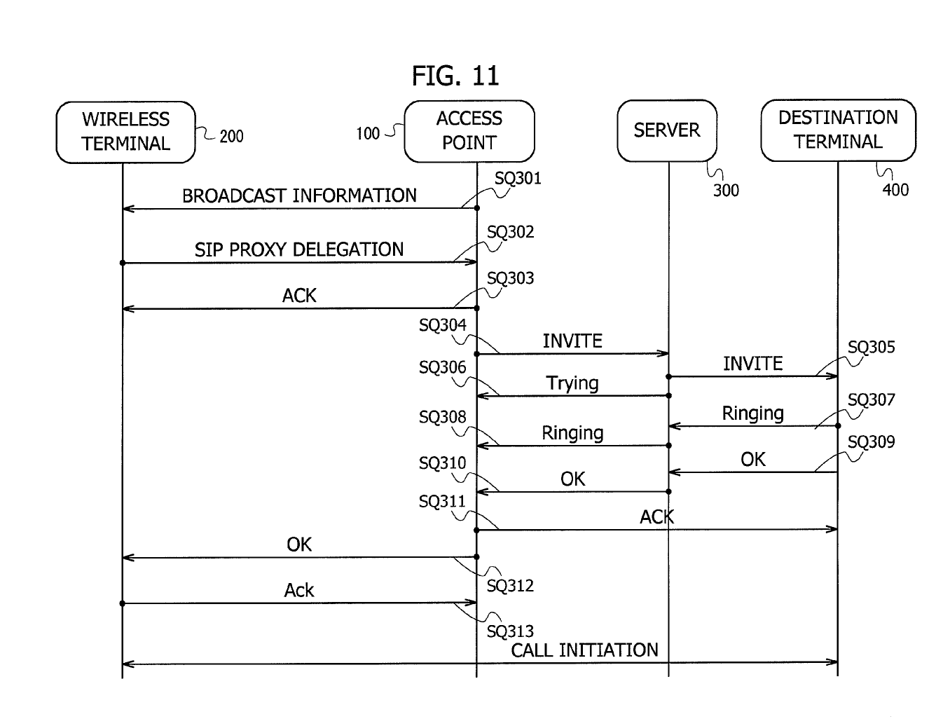

FIG. 11 illustrates an example of an operation sequence for the present modification. The operation sequence in FIG. 11 illustrates an example of the operation sequence of the access point 100, the wireless terminal 200, the server 300, and the destination terminal 400. The destination terminal 400 is a terminal called by the wireless terminal 200. The destination terminal 400 has a function of enabling SIP calling through a network. The destination terminal 400 can be implemented, for example, by a computer. The destination terminal 400 is an example of the terminal.

The access point 100 transmits notification information toward wireless terminals present around the access point 100 every predetermined time (SQ301). Here, the notification information includes information indicating that the access point 100 has a SIP proxy function.

From the notification information, the wireless terminal 200 recognizes that the access point 100 has the SIP proxy function.

The wireless terminal 200 transmits a frame containing information indicating the SIP proxy delegation and information about the destination terminal 400 as the calling destination to the access point 100 (SQ302). The access point 100 is an access point having the SIP proxy function. The wireless terminal 200 transmits the information indicating the SIP proxy delegation to the access point 100, whereby the wireless terminal 200 can delegate the exchange for call initiation using the SIP with the server 300 and the destination terminal 400 to the access point 100.

The access point 100 receives a frame from the wireless terminal 200. In response to the received frame, the access point 100 transmits the acknowledgement response (ACK) to the wireless terminal 200 (SQ303).

From the information indicating the SIP proxy delegation in the received frame, the access point 100 recognizes that the SIP proxy is delegated. The access point 100 extracts information about the calling destination from the received frame. The access point 100 transmits a request (INVITE) to start a SIP session to the server 300 (SQ304). The request includes information about the destination terminal 400.

The server 300 transmits the request (INVITE) to start the session to the destination terminal 400 (SQ305). The server 300 also transmits a signal (Trying) indicating trying to start the session to the access point 100 (SQ306).

The destination terminal 400 transmits a response signal (Ringing) indicating calling to the server 300 (SQ307). When the response signal is received, the server 300 transmits the response signal (Ringing) to the access point 100 (SQ308).

When a user or the like of the destination terminal 400 responds to the call, the destination terminal 400 transmits an accept signal (OK) indicating that the request is accepted, to the server 300 (SQ309). When the accept signal (OK) is received, the server 300 transmits the accept signal (OK) to the access point 100 (SQ310).

When the accept signal is received, the access point 100 transmits the accept acknowledgement signal (ACK) to the destination terminal 400 (SQ311).

The access point 100 also transmits the accept signal (OK) to the wireless terminal 200 (SQ312). When the accept signal (OK) is received, the wireless terminal 200 transmits the accept acknowledgement signal (ACK) to the access point 100 (SQ313).

This starts a call using the SIP between the wireless terminal 200 and the destination terminal 400.

Here, the server 300 is assumed to be one server, but the signal between the access point 100 (or the wireless terminal 200) and the destination terminal 400 may pass through a plurality of servers.

The configuration of the aforementioned embodiment and the configuration of each modification can be implemented in combination thereof as much as possible. The wireless terminal 200 may delegate a plurality of proxy functions to the access point 100. For example, the wireless terminal 200 may delegate the TCP proxy and the SSL proxy to the access point 100.

Here, the first modification and the second modification have been described using the SSL proxy and the SIP proxy respectively, but other applications using the TCP may be delegated to the access point 100 in a similar manner.

<Communication Between Wireless Terminal and Access Point>

The above configuration may allow any communication method to be adopted as the communication method between the wireless terminal 200 and the access point 100. Here, the description will focus on an example of the communication method between the wireless terminal 200 and the access point 100. The communication method to be described herein does not limit the communication method between the wireless terminal 200 and the access point 100 according to the present embodiment.

The use of the communication method to be described herein will improve bandwidth usage efficiency between the wireless terminal 200 and the access point 100.

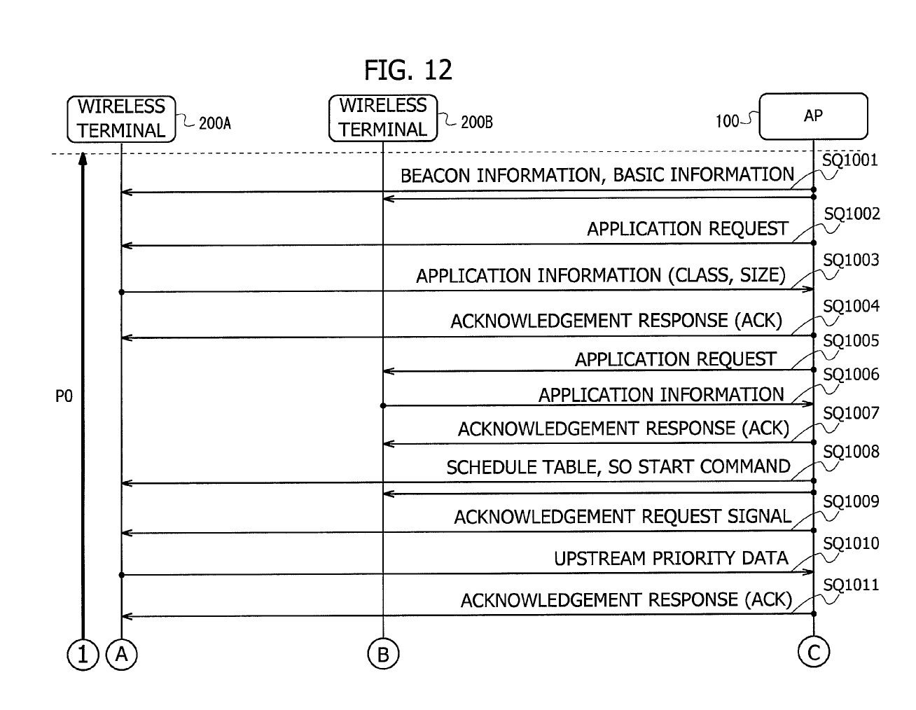

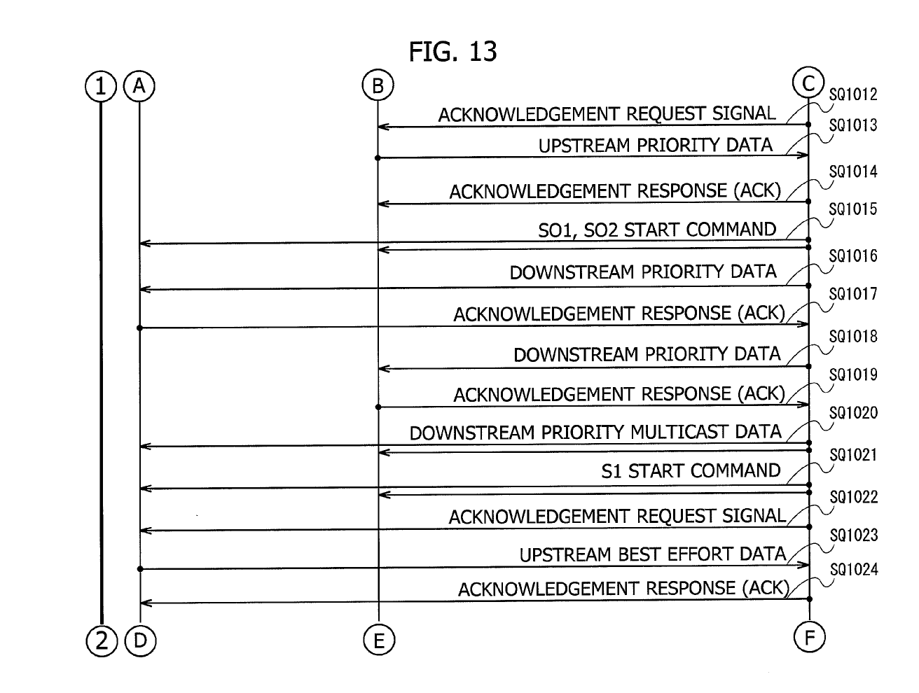

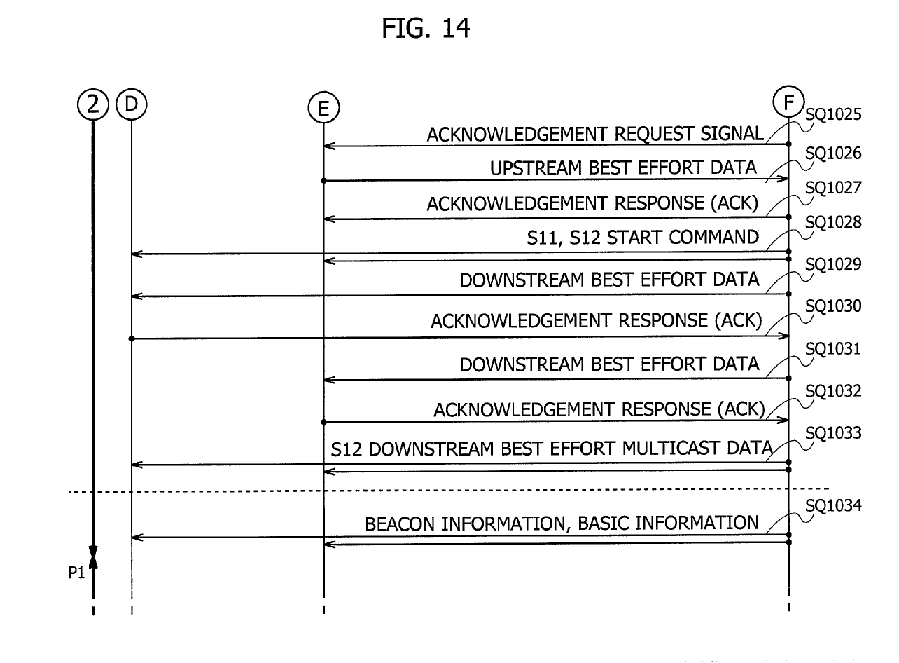

FIGS. 12, 13, and 14 each illustrate an example of the operation sequence of the communication method between wireless terminals and the access point. Here, the description will focus on the operation between a wireless terminal 200A and a wireless terminal 200B and the access point 100. The wireless terminal 200A and the wireless terminal 200B each have the same configuration as that of the wireless terminal 200. “A”, “B”, and “C” in FIG. 12 are connected to “A”, “B”, and “C” in FIG. 13 respectively. “1” in FIG. 12 is connected to “1” in FIG. 13. “D”, “E”, and “F” in FIG. 13 are connected to “D”, “E”, and “F” in FIG. 14 respectively. “2” in FIG. 13 is connected to “2” in FIG. 14.

It is assumed that the connection between the access point 100 and the wireless terminal 200A, and the connection between the access point 100 and the wireless terminal 200B have been completed by execution of a known communication procedure according to IEEE 802.11 and the like. The execution of the communication procedure allows the access point 100 to acquire identifiers for identifying wirelessly connected wireless terminal 200A and wireless terminal 200B. As used herein, the term “upstream” refers to a direction from the wireless terminal 200 toward the access point 100; and the term “downstream” refers to a direction from the access point 100 toward the wireless terminal 200.

The access point 100 transmits notification information to all the wireless terminals 200 wirelessly connected to the access point 100 itself (here, the wireless terminal 200A and the wireless terminal 200B) (SQ1001). This starts a basic period (P0).

The notification information is information of the access point 100 notified to the wireless terminal 200. The notification information includes basic information, identification information of the access point 100, information indicating having a predetermined proxy function, and the like.

Examples of the basic information include information about the protocol ID, the length of one period (length of one basic period), the number of users, the broadcast program, and the like. The protocol ID is identification information indicating the communication system according to the present embodiment. Here, the identification information is referred to as “VDFX”. When the basic information containing the protocol ID is received, the wireless terminal 200 recognizes that the communication with the access point 100 is performed by the communication system described herein. As used herein, the length of the basic period is assumed to be 100 ms. The length of the basic period is not limited to 100 ms. The number of users is the number of wireless terminals 200 connected to the access point 100. Examples of the broadcast program include a program table of broadcast programs using audio data and video data transmitted as multicast data. The user of the wireless terminal 200 can select a broadcast program to watch based on the program table.

The access point 100 transmits an application request to the wireless terminal 200A as a first wireless terminal (SQ1002). The application request is a signal for requesting the wireless terminal 200 to inform the access point 100 of the size of data and the class of data that the wireless terminal 200 tries to transmit to the access point 100. Examples of the class (priority) of data include an H type and a BE type. The H (High) type indicates data with a high priority. The BE (Best Effort) type indicates data with a low priority. Examples of the data with a high priority include data that needs a real-time property. Examples of the data with a high priority include data of an IP phone. The application request is a request for information about data scheduled to be transmitted in a basic period (P0). The data with a high priority is also referred to as priority data. The data with a low priority is also referred to as best effort data. The best effort data is an example of non-priority data.

When an application request addressed to the wireless terminal 200A is received from the access point 100, the wireless terminal 200A generates the size of data and the class of data that the wireless terminal 200A itself tries to transmit as application information (response) and transmits the application information to the access point 100 (SQ1003). If the wireless terminal 200A does not have data to be transmitted, the wireless terminal 200A transmits the application information indicating that there is no data to be transmitted to the access point 100. The application information may contain information other than the size of data and the class of data.

When the application information is received from the wireless terminal 200A, the access point 100 stores the information (the size of data and the class of data) contained in the application information in the memory 104.

The access point 100 transmits the acknowledgement response (Ack) to the application information to the wireless terminal 200A (SQ1004). Then, the access point 100 transmits an application request to the wireless terminal 200B as a second wireless terminal (SQ1005). The access point 100 may collectively transmit the acknowledgement response to the wireless terminal 200A and the application request to the wireless terminal 200B. Collective transmission takes shorter time than separate transmission.

When an application request is received from the access point 100, the wireless terminal 200B generates the size of data and the class of data that the wireless terminal 200B itself tries to transmit as application information and transmits the application information to the access point 100 (SQ1006). If the wireless terminal 200B does not have data to be transmitted, the wireless terminal 200B transmits the application information indicating that there is no data to be transmitted to the access point 100.

When the application information is received from the wireless terminal 200B, the access point 100 stores the information (the size of data and the class of data) contained in the application information in the memory 104. Then, the access point 100 transmits the acknowledgement response (Ack) to the application information to the wireless terminal 200B (SQ1007).

When the application information is not received from the wireless terminal 200 after a predetermined time has elapsed since the application request was transmitted to the wireless terminal 200, the access point 100 determines that the wireless terminal 200 does not have data to be transmitted.

The access point 100 generates a schedule table based on the application information received from each of the wireless terminals 200, the size of data transmitted from a higher level device to the wireless terminals 200, and the like. The schedule table is generated for each of the upstream priority data, downstream priority data, downstream priority multicast data, upstream best effort data, downstream best effort data, and upstream multicast best effort data. The schedule table of the downstream data is generated based on data addressed to the wireless terminal 200 received from the higher level device through a network, and the like. The schedule table is a schedule table about the basic period (P0). The schedule table is an example of schedule information.

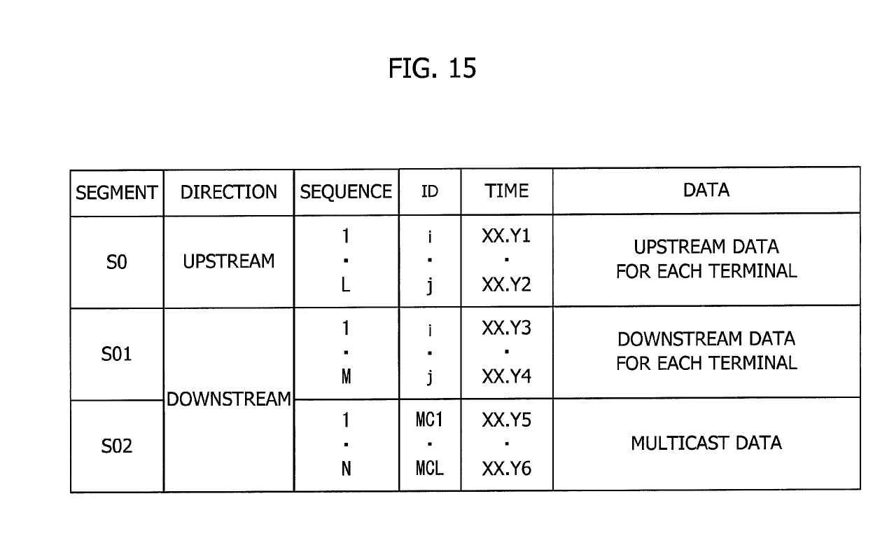

FIG. 15 illustrates an example of a schedule table of priority data. The schedule table of priority data includes segment, direction, sequence, ID, and time fields. The segment “S0” refers to transmission of upstream priority data. The segment “S01” refers to transmission of downstream priority data. The segment “S02” refers to transmission of downstream priority multicast data. The direction refers to upstream or downstream. The ID is an identifier identifying each wireless terminal 200. The time refers to the start time of the time allocated to transmit predetermined data. The allocated time is determined based on the size of data scheduled to be transmitted. For example, the time allocated to the wireless terminal 200 scheduled to transmit 864 bytes of data is 100 μs calculated by adding data transmission time 70 μs to response time limit 30 μs at 100 Mbps. The data transmission time is calculated from the communication speed between the access point 100 and the wireless terminal 200, and the size of data (data transmission time=data size/communication speed). The response time limit refers to the time that the access point 100 waits for a response. The response time limit may be preset to a predetermined value. If the data or the acknowledgement response is not transmitted after the response time limit is exceeded, the access point 100 may perform the following process. The time allocated to the multicast data may include no response time limit. This is because the access point 100 does not request the acknowledgement response to the multicast data.

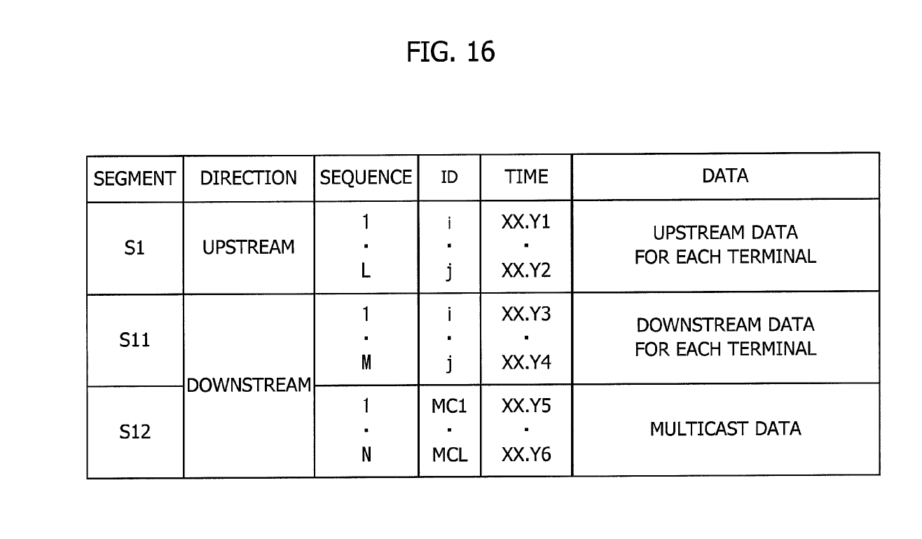

FIG. 16 illustrates an example of a schedule table of best effort data. Like the schedule table of priority data, the schedule table of best effort data includes segment, direction, sequence, ID, and time fields. The segment “S1” refers to transmission of upstream best effort data. The segment “S11” refers to transmission of downstream best effort data. The segment “S12” refers to transmission of downstream best effort multicast data.

The access point 100 generates the schedule table so that data can be transmitted within the basic period (P0) of 100 ms. If the size of data scheduled to be transmitted is too large to be transmitted within the basic period (P0), part of the best effort data is excluded from the schedule table. The best effort data excluded from the schedule table may be determined in any manner.

The access point 100 transmits all the generated schedule tables and an S0 start command to all the wireless terminals 200 (SQ1008). This starts to transmit and receive the priority data between the access point 100 and the wireless terminals 200. The S0 start command is a signal informing the wireless terminals 200 of the start of the segment “S0”.

The access point 100 transmits an acknowledgement request signal to the wireless terminal 200A as the first wireless terminal according to the schedule table (SQ1009). The acknowledgement request signal is a signal for requesting the wireless terminal 200 to transmit priority data to the access point 100, the priority data that the wireless terminal 200 tries to transmit to the access point 100. The acknowledgement request signal addressed to the wireless terminal 200A as the first wireless terminal may be transmitted together with the S0 start command in the sequence SQ1008.

When the acknowledgement request signal addressed to the wireless terminal 200A is received from the access point 100, the wireless terminal 200A transmits the priority data reported to the access point 100 in the application request to the access point 100 (SQ1010).

When the priority data is received from the wireless terminal 200A, the access point 100 transmits the acknowledgement response to the wireless terminal 200A (SQ1011). The access point 100 also transmits the acknowledgement request signal to the wireless terminal 200B as the second wireless terminal according to the schedule table (SQ1012). The access point 100 may collectively transmit the acknowledgement response to the wireless terminal 200A and the acknowledgement request signal to the wireless terminal 200B. Collective transmission takes shorter time than separate transmission. Further, the access point 100 transmits the received priority data to the destination of the priority data through the network.

If the acknowledgement response to the priority data transmission is not received, the wireless terminal 200A may report the transmission of the priority data again when a next application request is received, and then may try to transmit the priority data.

When the acknowledgement request signal addressed to the wireless terminal 200B is received from the access point 100, the wireless terminal 200B transmits the priority data reported to the access point 100 in the application request to the access point 100 (SQ1013).

When the priority data is received from the wireless terminal 200B, the access point 100 transmits the acknowledgement response to the wireless terminal 200B (SQ1014).

If the data or the acknowledgement response is not transmitted after the response time limit is exceeded, the access point 100 may perform the following process. In this case, the access point 100 may update the schedule table. For example, when the schedule is accelerated because the data or the like is not transmitted, the access point 100 can insert the transmission and reception of the best effort data into the schedule table, the best effort data being excluded from the schedule table when the schedule table was generated. The access point 100 transmits the updated schedule table to the wireless terminal 200, for example, together with the start command.

The access point 100 does not transmit the acknowledgement request signal for requesting the wireless terminal 200 having no priority data to be transmitted to transmit the priority data.

The access point 100 transmits the S01 and S02 start commands to all the wireless terminals 200 (SQ1015). The S01 and S02 start commands are signals informing the wireless terminals 200 of the start of the segment “S01” and the segment “S02” respectively.

The access point 100 transmits the downstream priority data addressed to the wireless terminal 200A to the wireless terminal 200A as the first wireless terminal according to the schedule table (SQ1016).

When the downstream priority data addressed to the wireless terminal 200A is received from the access point 100, the wireless terminal 200A transmits the acknowledgement response to the access point 100 (SQ1017).

When the acknowledgement response is received from the wireless terminal 200A, the access point 100 transmits the downstream priority data addressed to the wireless terminal 200B to the wireless terminal 200B according to the schedule table (SQ1018).

When the downstream priority data addressed to the wireless terminal 200B is received from the access point 100, the wireless terminal 200B transmits the acknowledgement response to the access point 100 (SQ1019).

When the downstream priority data is received, the wireless terminal 200 stores the received data in the memory 204 and performs a predetermined process on the received data.

Even if the acknowledgement response is not received after a predetermined time has elapsed since the downstream priority data was transmitted, the access point 100 may transmit the following downstream priority data according to the schedule table.

When the transmission of all the downstream priority data contained in the schedule table has completed, the access point 100 transmits the downstream priority multicast data to all the wireless terminals 200 according to the schedule table (SQ1020). The downstream priority multicast data is multicast data with a high priority.

The access point 100 transmits the S1 start command to all the wireless terminals 200 (SQ1021). This starts to transmit and receive the best effort data between the access point 100 and the wireless terminals 200. The S1 start command is a signal informing the wireless terminals 200 of the start of the segment “S1”.

The access point 100 transmits the acknowledgement request signal to the wireless terminal 200A as the first wireless terminal according to the schedule table (SQ1022). The acknowledgement request signal is a signal for requesting the wireless terminal 200 to transmit best effort data to the access point 100, the best effort data that the wireless terminal 200 tries to transmit to the access point 100. The acknowledgement request signal addressed to the wireless terminal 200A as the first wireless terminal may be transmitted together with the S1 start command in the sequence SQ1021.

When the acknowledgement request signal addressed to the wireless terminal 200A is received from the access point 100, the wireless terminal 200A transmits the best effort data reported to the access point 100 in the application request to the access point 100 (SQ1023).

When the best effort data is received from the wireless terminal 200A, the access point 100 transmits the acknowledgement response to the wireless terminal 200A (SQ1024). The access point 100 also transmits the acknowledgement request signal to the wireless terminal 200B as the second wireless terminal according to the schedule table (SQ1025). The access point 100 may collectively transmit the acknowledgement response to the wireless terminal 200A and the acknowledgement request signal to the wireless terminal 200B. Collective transmission takes shorter time than separate transmission. Further, the access point 100 transmits the received best effort data to the destination of the best effort data through the network.

If the acknowledgement response to the best effort data transmission is not received, the wireless terminal 200A may report the transmission of the best effort data again when a next application request is received.

When the acknowledgement request signal addressed to the wireless terminal 200B is received from the access point 100, the wireless terminal 200B transmits the best effort data reported to the access point 100 in the application request to the access point 100 (SQ1026).

When the best effort data is received from the wireless terminal 200B, the access point 100 transmits the acknowledgement response to the wireless terminal 2006 (SQ1027).

The access point 100 does not transmit the acknowledgement request signal for requesting the wireless terminal 200 having no best effort data to be transmitted to transmit the best effort data.

The access point 100 transmits the S11 and S12 start commands to all the wireless terminals 200 (SQ1028). The S11 and S12 start commands are signals informing the wireless terminals 200 of the start of the segment “S11” and the segment “S12” respectively.

The access point 100 transmits the downstream best effort data addressed to the wireless terminal 200A to the wireless terminal 200A as the first wireless terminal according to the schedule table (SQ1029).

When the downstream best effort data addressed to the wireless terminal 200A is received from the access point 100, the wireless terminal 200A transmits the acknowledgement response to the access point 100 (SQ1030).

When the acknowledgement response is received from the wireless terminal 200A, the access point 100 transmits the downstream best effort data addressed to the wireless terminal 200B to the wireless terminal 200B according to the schedule table (SQ1031).

When the downstream best effort data addressed to the wireless terminal 200B is received from the access point 100, the wireless terminal 200B transmits the acknowledgement response to the access point 100 (SQ1032).

When the downstream best effort data is received, the wireless terminal 200 stores the received data in the memory 204 and performs a predetermined process on the received data.

When the transmission of all the downstream best effort data contained in the schedule table has completed, the access point 100 transmits the downstream best effort multicast data to all the wireless terminals 200 according to the schedule table (SQ1033). The downstream best effort multicast data is multicast data with a low priority. Examples of the data with a low priority include data that needs no real-time property.

This completes the basic period (P0) that started in the sequence SQ1001. In the same manner as in the sequence SQ1001, when the access point 100 transmits beacon information and basic information to the wireless terminals 200, the next basic period (P1) starts (SQ1034).

The schedule table generated by the access point 100 may be updated at any time. More specifically, if no response is received for a predetermined time from the wireless terminal 200 having the upstream transmission time allocated based on the application information, the acknowledgement request signal may be transmitted to the next wireless terminal 200 by accelerating the schedule. If the schedule is changed, the updated schedule table including the timing of transmitting each start command may be transmitted from the access point 100 to the wireless terminals 200.

Here, the configuration has been described such that the access point 100 transmits the acknowledgement request signal to the wireless terminals 200, and then the wireless terminal 200 transmits upstream data. However, the configuration may be changed such that the access point 100 does not transmit the acknowledgement request signal and the wireless terminal 200 transmits upstream data according to the schedule table received from the access point 100. This configuration eliminates the need for the access point 100 to transmit the acknowledgement request signal, thereby improving bandwidth usage efficiency.

The configuration of the aforementioned embodiment and the configuration of each modification can be implemented in combination thereof as much as possible.

### Operation and Advantage of Embodiment

The exchange with the server 300 using the TCP is delegated from the wireless terminal 200 to the access point 100. The access point 100 performs TCP communication with the server 300 on behalf of the wireless terminal 200. When response data is received from the server 300, the access point 100 transmits the response data to the wireless terminal 200.

The wireless terminal 200 can delegate the proxy of the procedure such as the TCP to the access point 100 by transmitting information indicating the proxy delegation by specifying a predetermined protocol and the like to the access point 100.

The TCP communication control messages transmitted and received between the access point 100 and the server 300 are not transmitted to the wireless terminal 200, which reduces the load of the wireless terminal 200. In addition, TCP communication control messages are not transmitted or received between the access point 100 and the wireless terminal 200, which improves the communication efficiency in wireless bandwidth between the access point 100 and the wireless terminal 200. Further, the proxy of the TCP function and the like is delegated to the access point 100, which reduces power consumption for wireless communication in the wireless terminal 200.

Disclosed embodiments may be implemented by a program executed by the information processing apparatus. In other words, in the disclosed configuration, each process in the above described embodiments can be identified as a program to be executed by the information processing apparatus or a computer-readable recording medium storing the program. Alternatively, in the disclosed configuration, each process in the above described embodiments may be identified as a method to be executed by the information processing apparatus. Still alternatively, the disclosed configuration may be identified as a system including the information processing apparatus that performs each process in the above described embodiments.

The aforementioned embodiment and each modification can provide a communication method for efficient communication in a communication through a wireless communication.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A wireless relay apparatus that is communicably connected to a wireless terminal through a wireless LAN (Local Area Network) each other and is communicably connected to an information processing apparatus through a WAN (Wide Area Network), the wireless relay apparatus comprising:
a wireless communication unit configured to receive a frame containing data specifying a predetermined first protocol in a higher layer payload type field in a layer 2 header from the wireless terminal; and
a processor configured to execute a process that causes the wireless relay apparatus to perform establishing a TCP (Transmission Control Protocol) connection to and from the information processing apparatus when the wireless communication unit receives the frame containing the data specifying the predetermined first protocol in the higher layer payload type field in the layer 2 header, wherein
the wireless communication unit transfers data received from the information processing apparatus to the wireless terminal.

2. The wireless relay apparatus according to claim 1, wherein
the frame containing the data specifying the predetermined first protocol in the higher layer payload type field in the layer 2 header includes an HTTP request,
the wireless relay apparatus includes a communication unit configured to transmit the HTTP request to the information processing apparatus and to receive a response to the HTTP request from the information processing apparatus, and
the wireless communication unit transfers the response to the HTTP request received by the communication unit to the wireless terminal.

3. The wireless relay apparatus according to claim 1, wherein
the wireless communication unit receives a frame containing data specifying a predetermined second protocol in the higher layer payload type field in the layer 2 header,
the establishing includes establishing an SSL (Secure Socket Layer) session with the information processing apparatus when the wireless communication unit receives the frame containing the data specifying the predetermined second protocol in the higher layer payload type field in the layer 2 header, and
the wireless communication unit transfers data for use in the SSL session to the wireless terminal.

4. The wireless relay apparatus according to claim 1, wherein
the information processing apparatus is connected to a terminal,
the wireless communication unit receives a frame containing data specifying a predetermined third protocol in the higher layer payload type field in the layer 2 header,
the establishing includes establishing a SIP (Session Initiation Protocol) session with the terminal connected to the information processing apparatus when the wireless communication unit receives the frame containing the data specifying the predetermined third protocol in the higher layer payload type field in the layer 2 header, and
the wireless communication unit transfers data received from the terminal to the wireless terminal.

5. A communication system that includes a wireless terminal and a wireless relay apparatus communicable with each other through a wireless LAN (Local Area Network), wherein the wireless relay apparatus is communicably connected to an information processing apparatus through a WAN (Wide Area Network), wherein
the wireless terminal comprising
a wireless communication unit configured to transmit a frame containing data specifying a predetermined first protocol in a higher layer payload type field in a layer 2 header to the wireless relay apparatus,
the wireless relay apparatus comprising:
a wireless communication unit configured to receive the frame containing the data specifying the predetermined first protocol in the higher layer payload type field for the layer 2 header; and
a processor configured to execute a process that causes the wireless relay apparatus to perform establishing a TCP (Transmission Control Protocol) connection to and from the information processing apparatus when the wireless communication unit receives the frame containing the data specifying the predetermined first protocol in the higher layer payload type field in the layer 2 header, and
the wireless communication unit of the wireless relay apparatus transfers data received from the information processing apparatus to the wireless terminal.

6. The communication system according to claim 5, wherein
the frame containing the data specifying the predetermined first protocol in the higher layer payload type field in the layer 2 header includes an HTTP request,
the wireless relay apparatus includes a communication unit configured to transmit the HTTP request to the information processing apparatus and to receive a response to the HTTP request from the information processing apparatus, and
the wireless communication unit of the wireless relay apparatus transfers the response to the HTTP request to the wireless terminal.

7. The communication system according to claim 5, wherein the wireless communication unit of the wireless terminal transmits a frame containing data specifying a predetermined second protocol in the higher layer payload type field for the layer 2 header to the wireless relay apparatus,
the wireless communication unit of the wireless relay apparatus receives the frame containing the data specifying the predetermined second protocol in the higher layer payload type field for the layer 2 header, and
the establishing by the wireless relay apparatus includes establishing an SSL (Secure Socket Layer) session with the information processing apparatus when the wireless communication unit receives the frame containing the data specifying the predetermined second protocol in the higher layer payload type field in the layer 2 header, and
the wireless communication unit of the wireless relay apparatus transfers data for use in the SSL session to the wireless terminal.

8. The communication system according to claim 5, wherein
the information processing apparatus is connected to a terminal,
the wireless communication unit of the wireless terminal transmits a frame containing data specifying a predetermined third protocol in the higher layer payload type field in the layer 2 header to the wireless relay apparatus,
the wireless communication unit of the wireless relay apparatus receives the frame containing the data specifying the predetermined third protocol in the higher layer payload type field in the layer 2 header,
the establishing by the wireless relay apparatus includes establishing a SIP (Session Initiation Protocol) session with the terminal connected to the information processing apparatus when the wireless communication unit receives the frame containing the data specifying the predetermined third protocol in the higher layer payload type field in the layer 2 header, and
the wireless communication unit of the wireless relay apparatus transfers data received from the terminal to the wireless terminal.

9. A communication method for a communication system that includes a wireless terminal and a wireless relay apparatus communicable with each other through a wireless LAN (Local Area Network), wherein the wireless relay apparatus is communicably connected to an information processing apparatus through a WAN (Wide Area Network), the communication method comprising:
first transmitting, by the wireless terminal, a frame containing data specifying a predetermined first protocol in a higher layer payload type field in a layer 2 header to the wireless relay apparatus;
establishing, by the wireless relay apparatus, a TCP (Transmission Control Protocol) connection to and from the information processing apparatus when the frame containing the data specifying the predetermined first protocol in the higher layer payload type field in the layer 2 header is received; and
transferring, by the wireless relay apparatus, data received from the information processing apparatus to the wireless terminal.

10. The communication method according to claim 9, wherein
the frame containing the data specifying the predetermined first protocol in the higher layer payload type field in the layer 2 header includes an HTTP request, the communication method further comprising:
the first transmitting, by the wireless relay apparatus, includes transmitting the HTTP request to the information processing apparatus; and
second transmitting, by the wireless relay apparatus, a response to the HTTP request to the wireless terminal when the response to the HTTP request is received from the information processing apparatus.

11. The communication method according to claim 9, wherein
the first transmitting includes transmitting a frame containing data specifying a predetermined second protocol in the higher layer payload type field in the layer 2 header to the wireless relay apparatus;
the establishing includes establishing an SSL (Secure Socket Layer) session with the information processing apparatus when the frame containing the data specifying the predetermined second protocol in the higher layer payload type field in the layer 2 header is received; and
the transferring includes transferring data for use in the SSL session to the wireless terminal.

12. The communication method according to claim 9, wherein
the first transmitting includes transmitting a frame containing data specifying a predetermined third protocol in the higher layer payload type field in the layer 2 header to the wireless relay apparatus;
the establishing includes establishing a SIP (Session Initiation Protocol) session with a terminal connected to the information processing apparatus when the frame containing the data specifying the predetermined third protocol in the higher layer payload type field in the layer 2 header is received; and
the transferring includes transferring data received from the terminal to the wireless terminal.
